(19) United States
(12) Patent Application Publication
(10) Pub. No.: US 2006/0284870 A1
(43) Pub. Date: Dec. 21, 2006

(54) Fast surface interpolation

(75) Inventors: Roberto Ardon, Paris (FR); Jean-Michel Lagrange, Moissy Cramayel (FR)

Correspondence Address: Philips Electronics North America Corporation;Corporate Patent Counsel, P O Box 3001, Briarcliff Manor, NY, 10510, US

(73) Assignee: Koninklijke Philips Electronics N.V.

(21) Appl. No.: 10/556,287

(22) PCT Filed: May 6, 2004
(86) PCT No.: PCT/IB04/01535

§ 371 Date: Nov. 9, 2005

(30) Foreign Application Priority Data
May 14, 2003 (EP) 03300013.4

(51) Int. Cl. G06T 15/40

(52) U.S. Cl. 345/421

(57) ABSTRACT

The invention relates to an imaging device DEV comprising means for interpolating SIP a surface D from a set S of paths. Said imaging device DEV includes determination means UIF for determining at least two closed termination curves C1 and C2, said termination curves C1 and C2 joining points of the set S of paths, namely one point for each path of the set S of paths, in such a way that the set S of paths constitutes a junction between the two termination curves C1 and C2. Said surface interpolation for interpolating a surface D is constrained according to the invention by said set S of paths and said termination curves C1 and C2. The invention enables very fast interpolation of a surface while providing an analytical expression of this surface.

### FIELD OF THE INVENTION

The invention relates to an imaging device comprising means for interpolating a surface from a set S of paths. The invention also relates to a method of interpolating a surface from a set of paths.

### BACKGROUND OF THE INVENTION

Such a method is known from Numerical recipes in C: the art of scientific computing (ISBN 0-521-43108-5), Copyright © 1988-1992 Cambridge University Press, p. 123 to 128. This document describes a method of interpolation that can be used for interpolating a surface in several dimensions. This method uses Splines. Said interpolation is realized from a set of points, which are generally scattered. This kind of interpolation doesn't allow using the fact that points are on curves. Information is thus lost for the interpolation.

Consequently, the resulting interpolated surface is not very accurate. Moreover, as the invention concerns points that are distributed on curves, the number of calculations is very large, resulting in an increase of the process time.

Moreover, this interpolation method requires inversion of matrix 5*5 for each set of 4 points assuming that the surface can be described by an equation such as S=z(x,y). This implies that a large number of calculations are required. Indeed, as Spline interpolation is not dedicated to interpolating a surface from curves, the results obtained are quite poor.

### SUMMARY OF THE INVENTION

It is an object of the present invention to propose an imaging device wherein an improved method for interpolating a surface is implemented, said surface passing through specific, previously defined, termination curves. Another object of the invention is to allow fast surface interpolation. Actually, as the method of the invention requires very few calculations, it allows fast surface interpolations. Another object of the invention is to provide an interpolated surface having an analytical expression.

Said imaging device according to the invention includes:

Determination means for determining at least two closed termination curves, said termination curves joining points of the set of paths, namely one point for each curve of the set of paths, in such a way that the set of paths join the two termination curves,

Surface interpolation means for interpolating a surface, said interpolation being constrained by said set S of paths and said termination curves.

The invention enables very fast and guided interpolation. Active models for extracting surfaces and segmenting objects using, for example, a minimization of a potential need an initialization of a good quality. This is a crucial step. The interpolated surface according to the invention is very fast and of a good quality. Thus it can advantageously be used as a first segmentation initialization, especially for medical images where the information from 3D images is very poor. Generally a practitioner manually initializes the segmentation process when 2D images are proposed. But in the case of 3D images, it is difficult for a practitioner to carry out a satisfactory initialization that allows an acceptable result, using classical segmentation tools using minimization of potential. Generally a simple geometric shape is used (sphere, cylinder, ellipsoid) in 3D but this yields results of too low quality. The invention addresses the problem of introducing some supplementary information for the initialization of the model. Termination curves actually constitute supplementary information and the invention enables to take into account this supplementary information.

In an advantageous embodiment, minimal paths constructed from one of the said termination curves constitute said set of paths. Said termination curves being effectively closed, they are one-dimensional curves and a curvilinear abscissa can thus be defined. Said curvilinear abscissa is then used to define points from which said set of minimal paths are defined.

In a specific embodiment, said termination curves are defined in a 2D image.

In a preferred embodiment, said termination curves are determined by the user. In this case, the user very advantageously introduces supplementary information. Thus the invention enables the user to control the initialization of the segmentation in 3D by a very simple operation that consists in drawing two (or more) termination curves.

### BRIEF DESCRIPTION OF THE DRAWINGS

The invention is described in detail hereafter with reference to the diagrammatic figures wherein:

FIG. 1 is a schematic illustration of the nature and structure of the set of paths and of the termination curves according to the invention;

FIG. 2 illustrates a sector defined by two paths;

FIG. 3 illustrates an extension of the invention;

FIG. 4a illustrates the result of a first step of an interpolation of surface according to the advantageous embodiment of the invention;

FIG. 4b illustrates the quality of the resulting interpolation according to the advantageous embodiment of the invention;

FIG. 5 is a schematic diagram of an imaging device in which the invention is implemented;

FIG. 6 is a schematic diagram of a method according to the invention.

### DESCRIPTION OF EMBODIMENTS

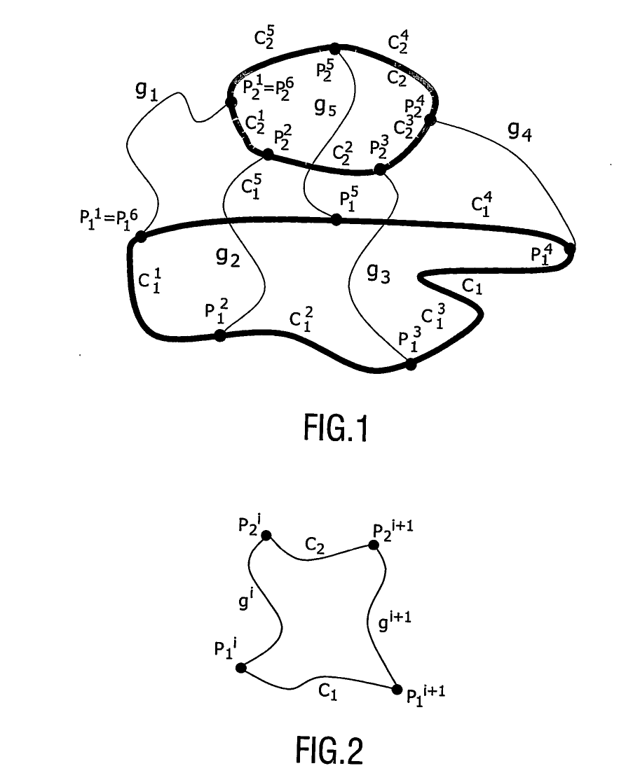

FIG. 1 gives a schematic illustration of the essential elements of the invention. This Figure thus gives a description of curves and paths necessary for the implementation of the invention. Two termination curves C1 and C2 are joined by a set of paths gⁱ with i=1 to 5. Only 5 paths are represented here for simplicity reasons. Surface interpolation means according to the invention then calculate an interpolation of the surface, said surface interpolation integrating information coming from the set of paths and from the two termination curves.

The interpolation of surface in accordance with the invention is an analytical path interpolation based on a local linear interpolation of each surface sector.

FIG. 2 presents such a sector, which is defined by two nearest minimal paths and the two portions of curves C₁ and C₂. Let s₁ and S₂ be arc-length parametrizations of C₁ and C₂ and C₁ⁱ and C₂ⁱ their restrictions to the i^{th} sector. The set of paths is denoted by gⁱ and P₁ⁱ and P₂ⁱ denote the arc-length abscissas of the intersection points of C₁, C₂ with paths gⁱ.

The invention proposes to introduce a function a which is strictly increasing and of class at least C¹.

This function σ creates the following correspondence between the arc-lengths of curves C₁ and C₂: s₂(P₂ⁱ)=σ(s₁(P₁ⁱ)). This allows the use of a common parametrization, denoted v, on both C₁ and C₂ and thus the same arc-length abscissas for the intersecting points Pⁱ. It is only required to change the parameter on C₂ because v=s₁.

Each path is parametrized in the same manner with the same parameter u, which takes its values on the interval [0,1]. The aim is to generate a parametrized surface D that is continuously differentiable and is parametrized with u and v. The essential constraint on D is to contain curves C₁, C₂ and all paths. In order to obtain continuity on the boundaries of the i^{th} sector, the restrictions Dⁱ of D must verify:

$$\{ \begin{matrix}{D}^{i} ( . , v ( {P}^{i} ) ) ≡ {g}^{i} \\ {D}^{i} ( 0 , . ) ≡ {C}_{1}^{i} \\ {D}^{i} ( 1 , . ) ≡ {C}_{2}^{i}\end{matrix} \qquad ( {E}_{1} )$$

If D is then imposed to satisfy the following condition, D will be at least a continuously differential surface parametrized by u and v.

$$\frac{\partial {D}^{i}}{\partial v} ( u , v ( {P}^{i + 1} ) ) = \frac{\partial {D}^{i + 1}}{\partial v} ( u , v ( {P}^{i + 1} ) ) \\ ∀ u ∈ [ 0 , 1 ] \qquad ( {E}_{2} )$$

The inventors show that there exist two functions α: 3² to 3³ and f: 3 to 3 of class at least C¹ verifying f(0)=0 and f(1)=1, such that the following expression of D satisfies the two above-presented equations (E1) and (E2).
Dⁱ(u,v)=αⁱ(u,v).[Cⁱ(u,v)−Cⁱ(u,v(Pⁱ))+g¹(u)]+(1−αⁱ(u,v))..[Cⁱ(u,v)−Cⁱ⁺¹(u,v(Pⁱ⁺¹))+gⁱ⁺¹(u)]
where
Cⁱ(u,v)=(1−ƒ(u).(C₁¹(v)+ƒ(u).C₂¹(σ(v))
with:

σ being a strictly increasing function, of class at least C1 on [0,1] which associates the curvilinear abscissas of curves C₁ and C₂ in the following equation: s₂(P₂ⁱ)=(v(P₁ⁱ))

f being a regular function such that: f(0)=0 and f(1)=1. For example, f(u)=(1−u)ⁿ is chosen and the value for n can be chosen (n=1.5 for example).

And the following definition:

$${α}^{i} ( u , v ) . = ( 1 - {v}^{i} ) + {v}_{i} ( 1 - {v}^{i} ) [ \frac{{A}^{i + 1} ( u )}{{A}^{i} ( u )} \times r ( i ) - 1 ] \cdot h ( {v}^{i} )$$

$$with \text{:}$$

$${v}_{i} = \frac{v - v ( {P}^{i} )}{v ( {P}^{i + 1} ) - v ( {P}^{i} )}$$

$$and \text{:}$$

$${A}^{i} ( u ) = {g}^{i + 1} ( u ) - {g}^{i} ( u ) - {C}^{i + 1} ( u , v ( {P}^{i + 1} ) ) + {C}^{i} ( u , v ( {P}^{i} ) ) ;$$

$$r ( i ) = \frac{v ( {P}^{i} ) - v ( {P}^{i + 1} )}{v ( {P}^{i + 2} ) - v ( {P}^{i + 1} )} ;$$

and h a regular function such that h(0)=0 and h(1)=1.

The man skilled in the art could easily check that the obtained expression for D verifies the two equations (E1) and (E2).

The main interest of this interpolation method is its interpolation speed. Actually only elemental calculations are needed to generate the surface. There is no need of any matrix inversion. Moreover, both information from the paths and from the initial curves are integrated in the process. Because of its capacity to integrate the information of the given curves, even when many paths are lacking, the interpolation is still satisfactory.

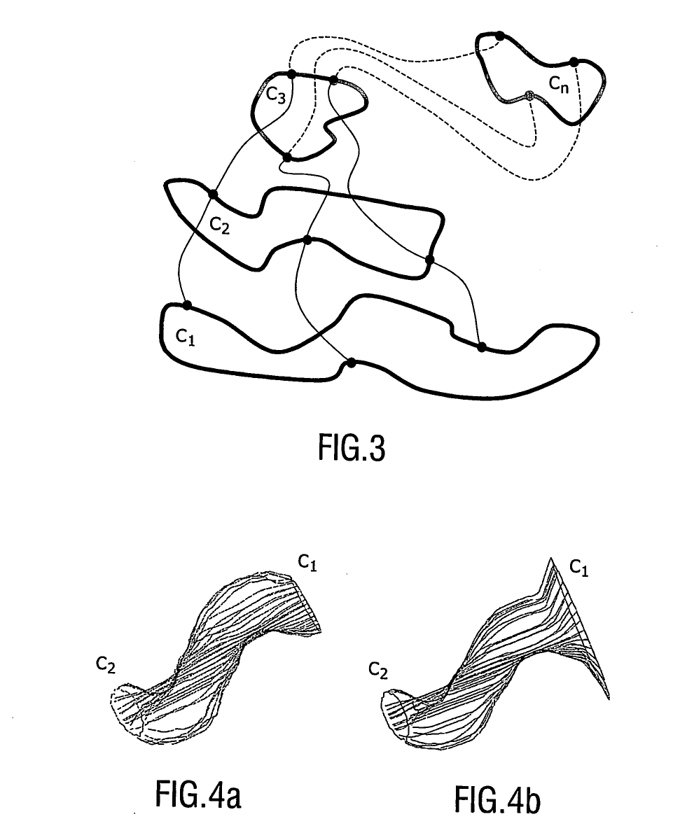

FIG. 3 illustrates a possible extension of the invention wherein several pairs of termination curves are defined with the help of the determination means. Surface interpolations according to the invention are realized between each pair of termination curves.

The surface defined by equation 1 is dependent on function αi. Thus, more general solutions can be obtained by finding function αi such that:

$$\{ \begin{matrix}- {α}_{i} ( u , v ( {P}_{i} ) ) = 1 , ∀ u ∈ [ 0 , 1 ] \\ - {α}_{i} ( u , v ( {P}_{i + 1} ) ) = 0 , ∀ u ∈ [ 0 , 1 ] \\ - {α}_{i} continuously differentiable with respect to s and S \\ - {A}_{i} ( u ) \frac{\partial {α}_{i}}{\partial v} ( u , v ( {P}_{i + 1} ) ) = {A}_{i + 1} ( u ) \frac{\partial {α}_{i + 1}}{\partial v} ( u , v ( {P}_{i + 1} ) )\end{matrix} \qquad ( E3 )$$

In this case the surface can also be differentiable through the termination curves as shown in FIG. 3. The function obtained allows the building of a continuously differentiable surface.

Thus, the invention gives the advantages of enabling the obtention of a surface that is parametrized by a curvilinear abscissa v on C₁ and the curvilinear abscissa u on each path gi, said parametrized surface being continuously differentiable with respect to v and u, which provides a surface with a very smooth aspect. Moreover, the surface interpolation according to the invention requires a small number of simple computations and is thus a very fast process. A last advantage is that the construction of the surface defined by the expression Dⁱ(u,v) can provide a large variety of solutions, depending mainly on the choice of the function αi. The man skilled in the art will recognize that other general forms can be found while verifying the conditions given in equation (E3).

In an advantageous embodiment, the set of paths is obtained by forming minimal paths constructed from one of the said termination curves.

The use of a set of minimal paths constructed from a termination curve to constitute the set of paths gⁱ is a new original feature.

The finding of minimal energy paths between two points in a 2D situation has been extended to a 3D situation in the publication by T. Deschamps and L. D. Cohen “3D minimal paths and application to virtual endoscopy”, in Mathematics and Image analysis, MIA'00, Paris, September 2000 and “minimal paths in 3D images and application to virtual endoscopy”, in Proceedings of the Sixth European Conference on Computer Vision (ECCV'00), Dublin, June 2000.

This finding of minimal paths is extended to finding minimal paths between a curve and a point in a 3D space according to the advantageous embodiment. C denotes a curve defined in a 3D image (C: vε3 to C(v)ε3³) and by a point p of 3³. A path g between C and p is a path g such that g(0)=p and g(L)εC, L being the length of g, parametrized by its arc-length. A minimal action map U is defined as the function that associates to each point p of 3³ the energy value of the minimal path to C:

$$U ( p ) = {inf}_{C ∈ H} \{ {\int }_{[ 0 , L ]}^{} \tilde{P} ( C ( v ) ) ⅆ v \}$$

where H is the set of all paths from p to C and P is a potential defined from the 3D image. Such a potential choice is described in the following.

The partial differential problem of the fast marching method has to be verified and the minimal action map U satisfies the Eickonal equation, only its zero level set being changed:
U⁻¹(0)=C

The man skilled in the art will then apply, for example, a numerical algorithm as presented in L. D. Cohen and T. Deschamps, “Grouping connected components using minimal path techniques. Application to reconstruction of vessels in 2D and 3D images”, in Proceedings of the IEEE Computer Society Conference on Computer Vision and Pattern Recognition (CVPR'01) using the points of C as the first trial points of the mean-heap structure.

In order to find the minimal path, the back-propagation starts from a given point in space and stops when a point of C is reached. Numerically, as C is a continuous curve in the invention, a convenient sampling operation is necessary in order to stop the back-propagation. This convenient sampling operation will take into account the size of the grid on which the back-propagation is realized and the fact that said propagation has to stop without zigzagging around C.

In the advantageous embodiment, two termination curves are defined prior to any calculation. In a specific embodiment, said termination curves are defined in a 2D image. Said 2D image is generally a section in 3D data and is presented to a user. Thus, in a preferred embodiment, said termination curves are determined by the user. In such a preferred embodiment a specific user interface enables the user to draw two closed curves on a 3D image.

The invention needs a set of several paths between said two termination curves. This set of paths is generally needed on a 3D image where a potential P is defined. This potential P advantageously represents the feature of the image in a mathematical format. For example, such a potential P takes lower values near the edges or features of a 3D image.

Thus in the advantageous embodiment of the invention the goal is to generate a set of minimal paths with respect to the potential P that join the two termination curves C₁ and C₂.

The minimal nature of such paths with respect to the cost function P ensures the proximity of features of the image. The choice of the potential is important in this case.

In an implementation of the invention, the following potential P is used. This potential P is given as an example and does not restrict the scope of the invention. Others potentials could be used by a man skilled in the art in order to take into account the feature of a 3D image.
P=α.g(|∇I_{σ}|)+(131 α)*h_{gap}(ΔI_{σ})
where g and h are two functions bounded to [0,1] and Iσ is the convolution of the given image with a gaussian kernel of variance σ.

The right choice for function g and h is restricted by the fact that the cost function should be high in areas where it is unlikely to encounter an edge. A simple choice for g can be the classical form:

$$g \text{:} x \to \frac{1}{1 + \frac{{x}^{2}}{{λ}^{2}}}$$

where λ is a contrast user-defined factor that could be computed as an average gradient value.

The h function is chosen to be a zero crossing detector that depends on a user defined constant gap. Because of the noisy nature of the Laplacian of an image, h_{gap} is set to be a binary map that detects only relevant zero crossing points of the Laplacian.

This potential allows a propagating front to rapidly advance in regions where edges are likely to be.

In order to generate the set of paths g, the minimal path between each point of C₂ and C₁ is computed. This is achieved by taking C₁ as the initialization of the fast marching method and solving the Eickonal equation related to U. A back-propagation procedure is then performed in order to find the path g such that:

$${g}^{p} = arg {min}_{C ∈ {H}_{p}} \{ {\int }_{[ 0 , L ]}^{} \tilde{P} ( C ( v ) ) ⅆ v \}$$

where Hₚ is the group of paths joining p to C1.

Thus, in the advantageous embodiment the generated set of minimal paths belongs to the surface to be interpolated.

An illustration of the generation of the set of paths according to the advantageous embodiment is presented in FIG. 4a. The constrained nature of the obtained set of paths is best observed when the imposed termination curves do not correspond to image features as presented in FIG. 4b, that illustrates the quality of the first step of the segmentation that consists in generating a set of paths close to the feature of the image.

In an alternative to the advantageous embodiment, the minimal paths are constrained geometrically to belong to planes.

It occurs that the features that are represented by the potential P cause the paths to merge, just like rivers descending from mountains to a valley. So, even with very smooth potentials, paths will merge. This is especially the case with ultrasound heart images where the majority of the paths merge. This causes an inaccurate interpolation.

To solve this problem, the back-propagation is constrained geometrically. Thus a manner to obtain a denser set of paths is to constrain the construction of said paths to planes. When back-propagating from a point p of C2, a plane is defined by three points: G1, mean point of C1, G2, mean point of C2 and p. While a normal gradient back-propagation is realized through the following equation:

$$\frac{ⅆ g}{ⅆ u} ( u ) = - ∇ U$$

$$g ( 0 ) = p$$

the following equation is used instead:

$$\frac{ⅆ g}{ⅆ u} ( u ) = - ∇ U + ( ∇ U \cdot \vec{n} ) \cdot \tilde{n}$$

$$g ( 0 ) = p \\ where \vec{n} = \frac{{G}_{1} {G}_{2} ⋀ {G}_{1} p}{‖ {G}_{1} {G}_{2} ⋀ {G}_{1} p ‖} ,$$

normal vector to the plane.

This equation ensures that the path g obtained belongs to this plane. The plane rotates while the point p describes the curve C1. This last alternative is very effective when dealing with objects that present some kind of rotational symmetry. In such a case, at each of its positions the plane will naturally be close to a meridian plane. Thus minimal paths will generate 2D segmentations on those planes and the final network will be denser.

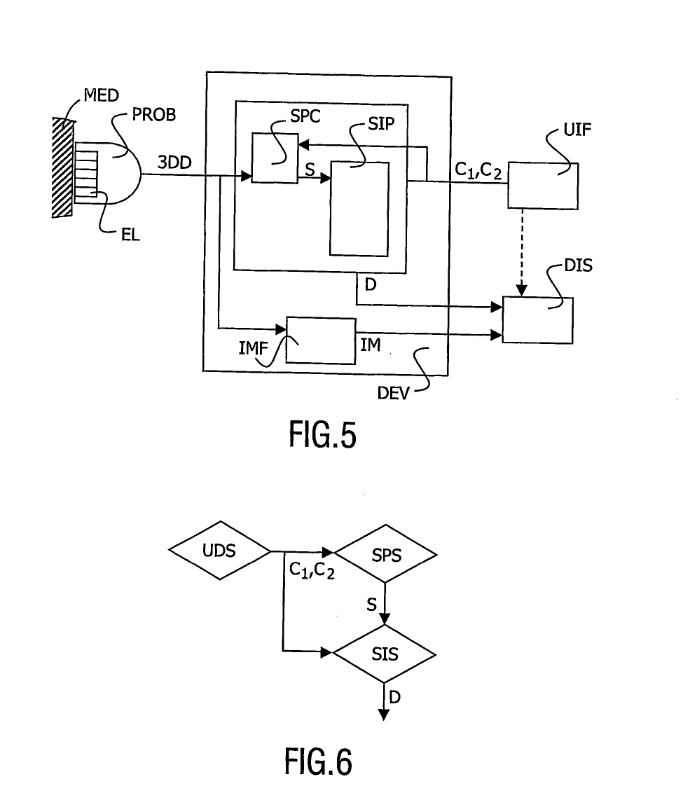

FIG. 5 is a schematic diagram of an imaging device DEV in which the invention is implemented. Said imaging device DEV is linked to acquisition means PROB. For example the imaging device is an ultrasound imaging device and acquisition means PROB are constituted by a probe including several transducer elements EL. This probe sends data 3DD related to what is observed in a 3D space. For example, a medium MED is observed with the probe and acquired data are representative of what is present in a volume of the medium MED. These data 3DD are sent to the imaging device of the invention. Within the imaging device, said data 3DD are supplied to an image construction module IMF that generates at least one image IM of the medium MED. This image is generally a 2D image that represents a section of the observed volume of the medium MED. Several images can also be constructed, allowing displacement through the volume. A 3D image is difficult to provide if no segmentation has been performed. This is the purpose of the invention. Such images are provided to display means DIS. Said display means DIS are for example constituted by a screen. In the preferred embodiment, two termination curves C₁ and C₂ are determined by a user through a user interface UIF. The user advantageously determines the curves C₁ and C₂ from what is visible on a 2D image presented on the display means. The user interface UIF can thus be constituted by a mouse, a keyboard, etc. with a dedicated piece of software allowing to draw a curve on the screen. Other means for determining two termination curves can also be used. For example, segmentation means on one 2D image, or preferably on two 2D images, can provide an automatic determination of the two termination curves. Such segmentation means are well known to the man skilled in the art.

Then, according to the advantageous embodiment of the invention, a set S of minimal paths is constructed by a construction module SPC between the two termination curves C₁ and C₂. This set S of paths and the two termination curves C₁ and C₂ are then used in a surface interpolation module SIP where a surface D is interpolated according to the calculations presented hereinabove. Said surface D represents a segmentation of the 3D data and can advantageously be displayed on display means DIS.

Said acquisition means PROB, user interface UIF and display means DIS are not represented as being part of said imaging device DEV, but it is useful to note that all these features can also be implemented directly within the imaging device DEV.

FIG. 6 is a schematic diagram for a method according to the advantageous embodiment of the invention. A determination step UDS of the two termination curves C₁ and C₂ is realized. This step allows to provide said curves C₁ and C₂ to a step of construction SPS of a set S of paths and to a surface interpolation step SIS. Said set S of paths is then provided to said step of surface interpolation. After the step of surface interpolation, a surface D is thus available.

The fast surface interpolation of the invention enables a practitioner to segment quickly the contour of an anatomical 3D object without intervention or with only a simple intervention. Moreover, for images that are more difficult to segment or that require very accurate segmentation, the robustness and the quality of the surface interpolation according to the invention allow a very good initialization for more accurate surface interpolation methods. A good initialization (close to real features) enables an accurate surface interpolation method to shorten the duration of calculation. Thus, this surface interpolation can be applied in real-time.

Presented figures are illustrative of special embodiments of the invention and are not restrictive. It will be apparent to those skilled in the art that many modifications and variations may be made to the exemplary embodiments of the present invention set forth hereinabove, without departing substantially from the principles of the present invention. All such modifications and variations are intended to be included herein.

1. An imaging device comprising means for interpolating a surface from a set S of paths, characterized in that said device includes:
Determination means for determining at least two closed termination curves, said termination curves joining points of the set of paths, namely one point for each path of the set of paths, in such a way that the set of paths constitutes a junction between the two termination curves,
said surface interpolation means for interpolating a surface being constrained by said set S of paths and said termination curves.

2. An imaging device according to claim 1, wherein said set of paths is constituted by minimal paths constructed from points linking (?) one of the said termination curves to the other termination curves.

3. An imaging device according to claim 2, wherein said minimal paths are constructed with a geometrical constraint.

4. An imaging device according to claim 3, wherein said geometrical constraint means that each path remains in one single plane.

5. An imaging device according to claim 1, wherein said termination curves are defined in a 2D image.

6. An imaging device according to claim 1, wherein said termination curves are determined by a user.

7. A surface interpolation method from a set of paths, characterized in that said method includes:
A determination step for determining at least two closed termination curves, said termination curves joining points of the set of paths, namely one point for each path of the set of paths, in such a way that the set of paths constitutes a junction between the two termination curves,
A surface interpolation step for interpolating a surface being constrained by said set S of paths and said termination curves.

8. A surface interpolation method as claimed in claim 7, wherein said set of paths is constituted during a step of construction of minimal paths, said minimal paths being constructed from points linking (?) one of the said termination curves to the other termination curves.
